(19) United States
(12) Patent Application Publication
(10) Pub. No.: US 2017/0031893 A1
(43) Pub. Date: Feb. 2, 2017

(54) Set-based Parsing for Computer-Implemented Linguistic Analysis

(71) Applicant: Pat Inc., Palo Alto, CA (US)

(72) Inventor: John Ball, Santa Clara, CA (US)

(21) Appl. No.: 15/222,399

(22) Filed: Jul. 28, 2016

Related U.S. Application Data
(60) Provisional application No. 62/198,684, filed on Jul. 30, 2015.

(51) Int. Cl. G06F 17/27; G06F 17/21; G10L 15/05

(52) U.S. Cl. CPC G06F 17/2705; G10L 15/05; G06F 17/2765; G06F 17/218; G06F 17/274

(57) ABSTRACT

The invention concerns linguistic analysis. In particular the invention involves a method of operating a computer to perform linguistic analysis. In another aspect the invention is a computer system which implements the method, and in a further aspect the invention is software for programming a computer to perform the method. The method comprising the steps of: receiving a list of elements, storing them in a list of sets, and then repeatedly matching patterns stored in the set's elements and storing their result in the list until no new matches are found. For each match comprising the steps: Creating a new consolidated set (overphrase) to store the full representation of the phrase as a new element, migrating the head element specified in the phrase, all phrase attributes, storing the matched elements in sequence, and copying tagged copies of the matched elements. After the consolidated set is created and filled, linkset intersections to effect WSD is performed. The resulting elements may be selected to identify the best fit, enabling effective WBI and PBI. The bidirectional nature of elements enables phrase generation to any target language.

### CROSS-REFERENCE TO RELATED APPLICATION

The present application claims priority from U.S. Provisional Application Ser. No. 62/198,684 for “Set-based Parsing for Linguistic Analysis”, filed Jul. 30, 2015, the disclosure of which is incorporated herein by reference.

### BACKGROUND

Field of the Invention

This invention relates to the field of computer-implemented linguistic analysis for human language understanding and generation. More specifically, it relates to Natural Language Processing (NLP), Natural Language Understanding (NLU), Automatic Speech Recognition (ASR), Interactive Voice Response (IVR) and derived applications including Fully Automatic High Quality Machine Translation (FAHQMT). More specifically, it relates to a method for parsing language elements (matching sequences to assign context and structure) at many levels using a flexible pattern matching technique in which attributes are assigned to matched-patterns for accurate subsequent matching. In particular the invention involves a method of operating a computer to perform language understanding and generation. In another aspect the invention is a computer system which implements the method, and in a further aspect the invention is software for programming a computer to perform the method.

Description of the Related Art

Today, many thousands of languages and dialects are spoken worldwide. Since computers were first constructed, attempts have been made to program them to understand human languages and provide translations between them.

While there has been limited success in some domains, general success is lacking. Systems made after the 1950s, mostly out of favor today, have been rules-based, in which programmers and analysts attempt to hand-code all possible rules necessary to identify correct results.

Most current work relies on statistical techniques to categorize sounds and language characters for words, grammar, and meaning identification. “Most likely” selections result in the accumulation of errors.

Parse trees have been used to track and describe aspects of grammar since the 1950s, but these trees do not generalize well between languages, nor do they deal well with discontinuities.

Today's ASR systems typically start with a conversion of audio content to a feature model in which features attempt to mimic the capabilities of the human ear and acoustic system. These features are then matched with stored models of phones to identify words, stored models of words in a vocabulary and stored models of word sequences to identify phrases, clauses and sentences.

Systems that use context frequently use the “bag of words” concept to determine the meaning of a sentence. Each word is considered based on its relationship to a previously analyzed corpora, and meaning determined on the basis of probability. The meaning changes easily by changing the source of the corpora.

No current system has yet produced reliable, human-level accuracy or capability in this field of related art. A current view is that human-level capability with NLP is likely around 2029, when sufficient computer processing capability is available.

### BRIEF SUMMARY OF THE INVENTION

An embodiment of the present invention provides a method in which complexity is recognized by combining patterns in a hierarchy. U.S. Pat. No. 8,600,736 B2, 2013 describes a method to analyze languages. The analysis starts with a list of words in a text: the matching method creates overphrases that representing the product of the best matches.

An embodiment of the present invention extends this overphrase to a Consolidated Set (CS), a set that consolidates previously matched patterns by embedding relevant details from the match and labelling them as needed. Matching of the initial elements or the consolidated set are equivalent.

The CS enables more effective tracking of complex phrase patterns. To track these, a List Set (LS) stores all matched patterns—a list of sets of elements. As a CS is an element, matching and storing of patterns simply verifies if a matched pattern has previously been stored. Parsing completes when no new matches are stored in a full parse round—looking for matches in each element of the LS.

As each parse round completes with the validation of meaning for the phrase, clause or sentence, invalid parses can be discarded regardless of their correct grammatical use in other contexts with other words.

The matching and storing method comprises the steps of: receiving a matched phrase pattern with its associated sequence of elements. For each match, creating a new CS to store the full representation of the phrase as a new element. To migrate elements, the CS stores the union of its elements with the sets identified.

Once the CS is created, it is filled with information defined in the phrase. Phrases with a head migrate all words senses from the head to the CS. Headless phrases store a fixed sense stored in the phrase that provides necessary grammatical category and word sense information.

Logical levels are created by the addition of level attributes, which serve also to inhibit matches.

All attributes in the phrases are stored in the CS. The CS is linked to the matched sequence of elements. The CS receives a copy of the matched elements with any tags identified by the phrase. Once the CS is created and filled, linkset intersections is invoked to effect Word Sense Disambiguation (WSD).

The resulting elements may be selected to identify the best fit, enabling effective WBI and PBI. The bidirectional nature of elements enables phrase generation.

### BRIEF DESCRIPTION OF THE DRAWINGS

FIG. 1 shows a phrase structure in which the sequence of patterns are allocated values to enable future tracking, and the resulting CS (Consolidated Set) receives attributes used for element level identification and inhibition.

FIG. 2 illustrates an LS (List of Sets) used to control a parse of elements.

FIG. 3 shows an example of three languages, some of which allow word order variation but which provide a single set representation.

FIG. 4 shows a Consolidated Set compared with a parse tree.

FIG. 5 explains 4 scenarios in which WSD, WBI and PBI are solved by an embodiment of the present invention.

FIG. 6 shows an embodiment of the present invention in which a matched-pattern overphrase is assigned a new attribute.

FIG. 7 shows how subsequent pattern-matches ignore the matched-pattern, effectively due to inhibition.

FIG. 8 shows how a pattern at another level makes use of the matched-pattern.

FIG. 9 illustrates how the repeated application of pattern matching results in the accumulation of complex, embedded patterns as a previously matched noun clause is matched in a clause.

FIG. 10 shows the generation process to convert matched phrases back to sequential phrases or new set phrases to sequential form. As phrases are identified with sets of attributes, the attribute sets effectively form levels for the control of matching order and consolidation.

FIG. 11 shows the equivalence between text, a collection of sequential phrases and meaning, the consolidation of matched patterns from the completed parse.

### DETAILED DESCRIPTION AND BEST MODE OF IMPLEMENTATION

An embodiment of the present invention provides a computer-implemented method in which complexity is built up by combining patterns in a hierarchy. U.S. Pat. No. 8,600,736 B2, 2013 describes a method to analyze language in which an overphrase, representing a matched phrase, is the product of a match. An embodiment of the present invention extends this overphrase to a Consolidated Set (CS), a data-structure set that consolidates previously matched patterns by embedding relevant details from the match and labelling them as needed. Matching automatically either initial elements or a consolidated set are equivalent. It also extends the patent as follows: instead of the analysis starting with a list of words in a text: the automatic matching method applies to elements that are sound features; written characters, letters or symbols; phrases representing a collection of elements (including noun phrases); clauses; sentences; stories (collections of sentences); or others. It removes the reliance on the ‘Miss snapshot pattern’ and ‘phrase pattern inhibition’ as the identification of the patterns is dealt with automatically when no more patterns are found.

A CS data structure links electronically to its matched patterns and automatically tags a copy of them from the matching phrase for further classification. It can re-structurally convert one or more elements to create a new set. Sets either retain a head element specified by the matching phrase or are structurally assigned a new head element to provide the CS with a meaning retained from the previous match, if desired.

Elements in the system modifiably decompose to either sets or lists. For written words in a language for example, they are transformationally represented as the list of characters or symbols, plus a set of word meanings and a set of attributes. For spoken words, these are a list of sound features, instead of characters. Pattern levels structurally separate the specific lists from their representations.

At a low level, a word data structure is a set of sequential lists of sounds and letters. Once matched, this data structure becomes a collection of sets containing specific attributes and other properties, like parts of speech. For an inflected language, for example, a word data structure is comprised structurally of its core meanings, plus a set of attributes used as markers. In Japanese, markers include particles like ‘ga’ that attach to a word; and in German articles like ‘der’ and ‘die’ mark the noun phrase. The electronic detection of patterns (such as particles) that automatically perform a specific purpose are embodied structurally as attributes at that level. To further illustrate the point, amongst other things, ‘der’ represents masculine, subject, definite elements—a set of attributes supporting language understanding.

Discontinuities in patterns and free word order languages which mark word uses by inflections are dealt automatically with in two steps. First, the elements are added structurally to a CS with the addition of attributes electronically to tag the elements for subsequent use. Second, the CS is matched structurally to a new level that automatically allocates the elements based on their marking to the appropriate phrase elements. While a CS data structure is stored in a single location, its length can span one or more input elements and it therefore structurally represents the conversion of a list to a set.

There is no limit to the number of attributes physically transformable in the system. Time may show that the finite number of attributes required is relatively small with data structure attribute sets creating flexibility as multiple languages are supported. To make use of the attribute accumulation for multi-level matching, pattern matching steps are repeated until there are no new matches found.

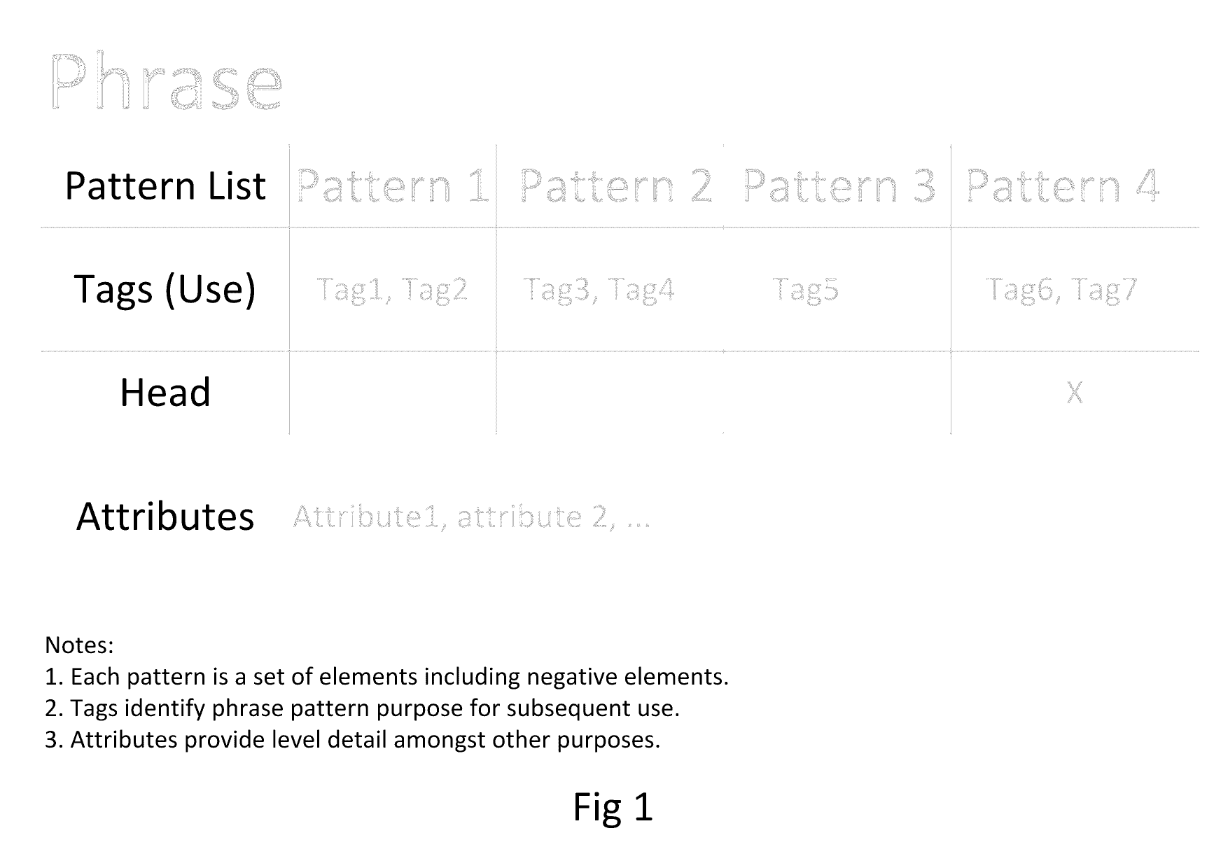

FIG. 1 shows the structured elements of a phrase. A matched phrase automatically returns a new, filled CS. The phrase's pattern list is comprised of a list of structured patterns. Each pattern is a set of data structure elements. When a pattern list is matched structurally, a copy of each element matched is stored automatically with the corresponding data structure tags to identify previous elements for future use. The head of the phrase structurally identifies the pattern lists' word senses to retain if present, or a fixed sense is identified otherwise. For level tracking, phrase attributes are added automatically to the CS.

The computer-implemented method comprises the software-automated steps of: electronically receiving a matched phrase pattern data structure with its associated sequence of data structure elements. For each match, electronically creating a new CS data structure to store the full representation of the phrase transformatively as a new data structure element. The CS data structure automatically stores the union of its data structure elements with the data structure sets identified electronically to migrate elements.

Once the CS data structure is created electronically, it is filled automatically with information data structure defined in the phrase. Phrases with a head migrate transformatively all word senses from the head element to the CS data structure. Headless phrases structurally store a fixed sense stored structurally in the phrase data structure to provide any necessary grammatical category and word sense information. The CS data structure is linked electronically to the sequence of data structure elements matched and also filled automatically with a copy of them with any data structure tags modifiably identified by the phrase. Linkset intersection automatically is invoked for the data structure phrase to effect WSD once the CS has been filled automatically. By only intersecting data structure copies of the tagged data structure elements, no corruption of stored patterns from the actual match is possible.

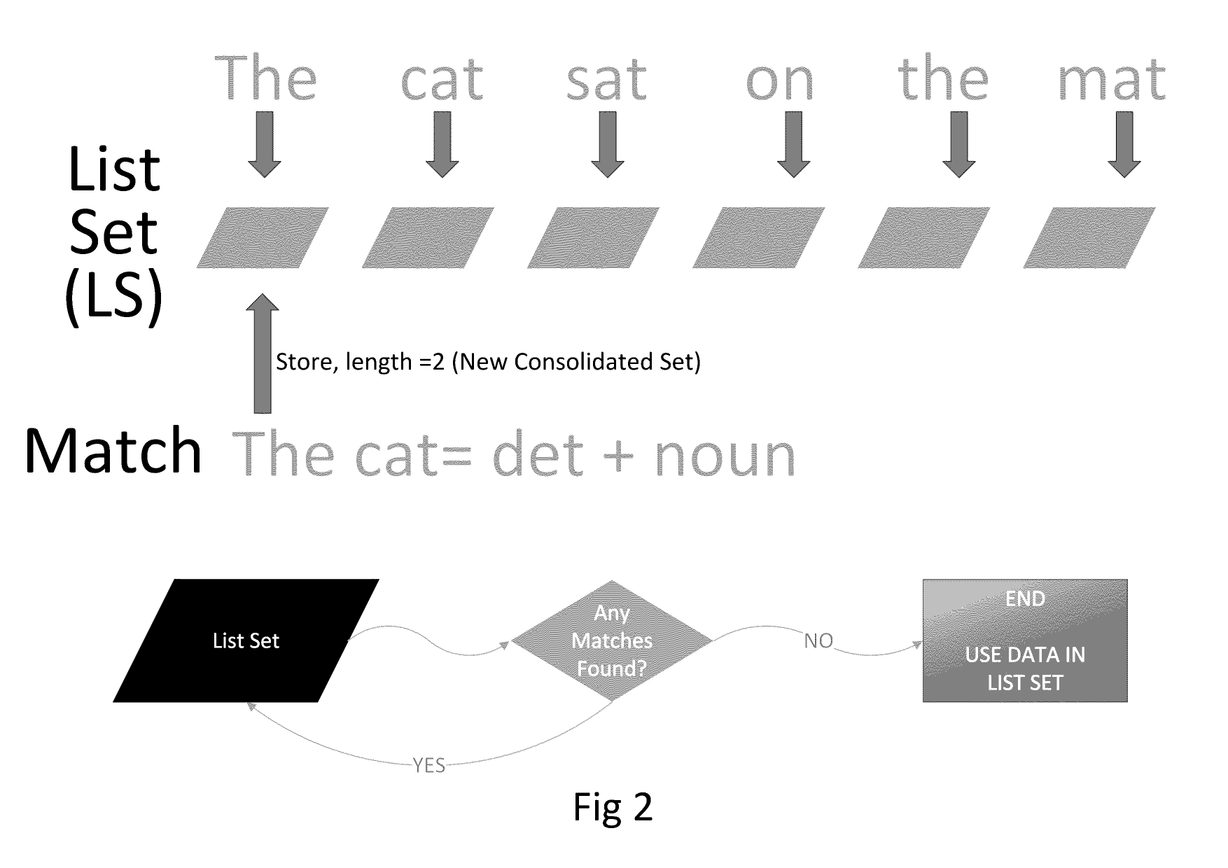

FIG. 2 illustrates a List Set (LS), a list of sets of data structure elements, used to track and control automatically a parse of data structure elements regardless of the element type or level. Received data structure elements are loaded electronically into an LS of the same length, and then the LS enables automatic pattern matching until no new matches are stored electronically. A new CS data structure is stored electronically where the phrase match begins structurally in the LS, with a length used automatically to identify where a phrase's next data structure element is in the LS. As the LS stores sets electronically, a new CS data structure is only added automatically if an equivalent CS isn't already stored. FIG. 2 also shows a computer-implemented method to determine automatically an end-point: the automated process stops when there are no new structural matches generated in a full match round. All stored patterns in the LS are candidates for automated matching in the system. The best choice may be assumed automatically to be the longest valid phrase that structurally incorporates the entire input text, or the set of these when ambiguous. Embedded clause elements structurally provide valid information and may be automatically used if the entire match is unsuccessful, to enable automated clarification of partial information as a “word/phrase boundary identification” benefit.

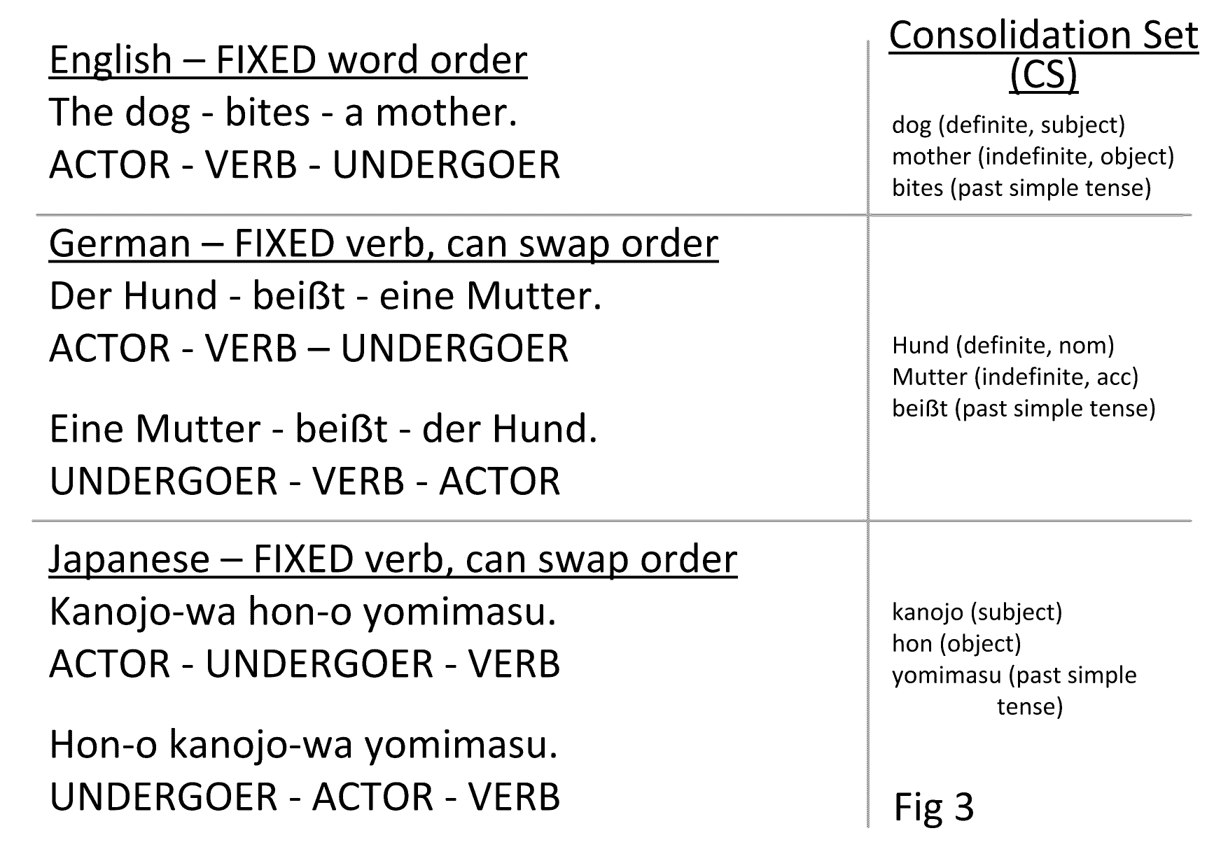

FIG. 3 shows a Consolidated Set comparison for languages with structurally different phrase sequence patterns for active voices. In English, there is one word order which defines the subject, object and verb. In German, the marking of the nouns by determiners specifies the role used with the verb. In traditional parse trees, these structurally represent two different trees, however there is only one Consolidated Set, shown in column 2 each with only 3 elements. Similarly in Japanese, the marking of the nouns determines the relationship to the verb, but structurally there are also two possible parse trees, and only one Consolidated Set. Other syntactic structures may add additional data structure attributes, such as with passive constructions, but retaining structurally the same three tagged CS elements with their word-senses.

The FIG. 3 illustration shows subject, object, acc and nom tags to identify to the CS structurally the markings of the tagged, embedded data structure elements. For efficiency and the avoidance of a combinatorial explosion of phrase patterns, more data structure granularity is desirable for non-clause level phrases prior to promotion to a clause level match. The clause level tags are readily mapped electronically from phrase-level tags, because nominal and subject marking can be addressed synonymously for active voice clauses.

The data structure hierarchy is made flexible by the addition of appropriate attributes that are assigned automatically at a match in one level to be used in another: creating multi-layer structures that electronically separate linguistic data structure components for effective re-use. Parsing automatically from sequences to structure uses pattern layers, logically created automatically with data structure attributes. While one layer can automatically consolidate a sequence into a data structure set, another can allocate the set to new roles transformatively as is beneficial to non-English languages with more flexible word orders. The attributes also operate structurally as limiters automatically to stop repeated matching between levels—an attribute will inhibit the repeat matching by structurally creating a logical level. The creation of structured levels allows multiple levels to match electronically within the same environment.

Attributes are intended to be created automatically only once and reused as needed. Attributes existing once per system supports efficient structural search for matches. There is no limit on the number allowed structurally. To expand an attribute, it is added structurally to a set of data structure attributes. These data structure sets act like attributes, matched and used electronically as a collection. For example, the attribute “present tense” can be added structurally with the attribute “English” to create transformatively an equivalent attribute “present tense English”.

While there are no limitations for specific language implementations, data structure tags electronically capture details about structurally embedded phrases for future use and attributes provide CS-level controls automatically to inhibit or enable future phrase matches. Attributes are used in particular to facilitate CS levels structurally where non-clauses are dealt with independently from clauses within the same matching environment. For example, this allows noun-headed clauses to be re-used automatically as nouns in other noun-headed clauses while electronically retaining all other clause level properties and clause-level WSD.

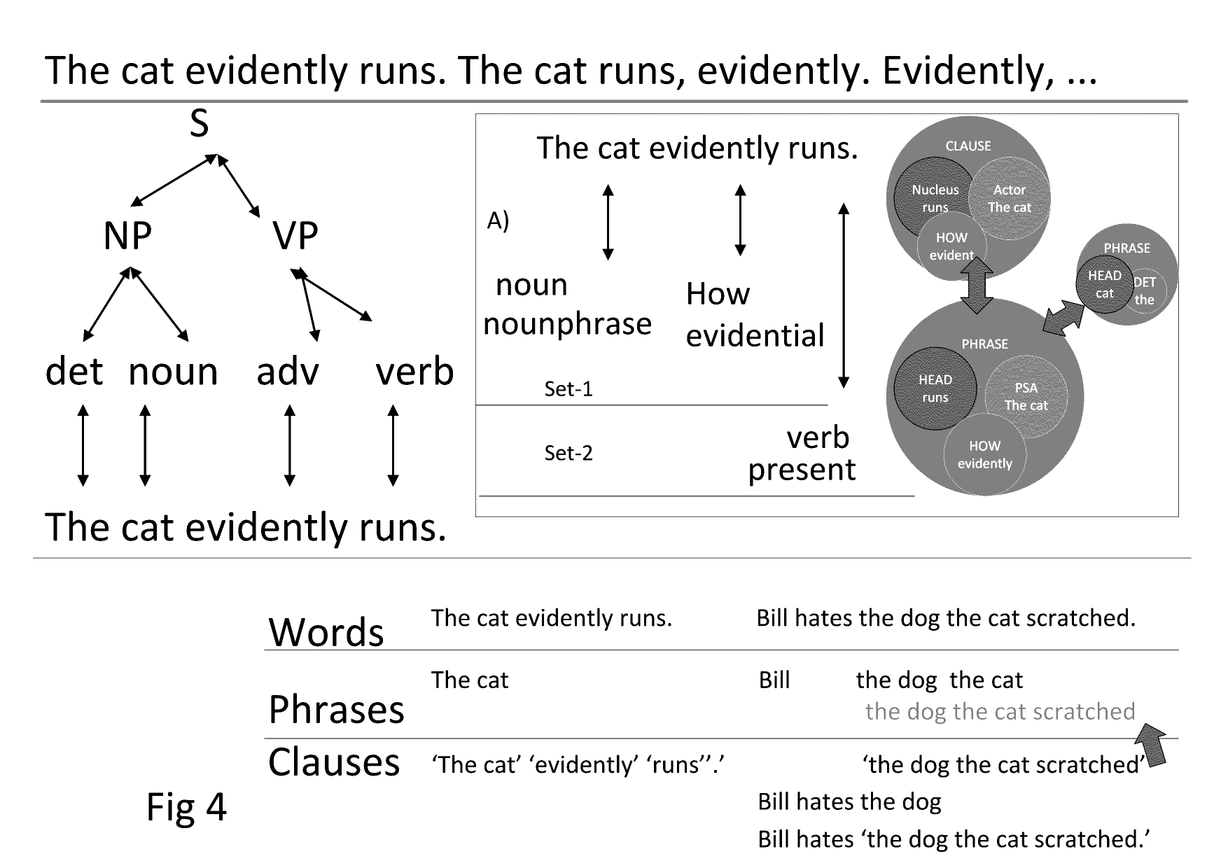

FIG. 4 shows a CS data structure compared with a parse tree. Since the 1950s, most linguistic models utilize parse trees to show phrase structure. To avoid the limitations of that model due to lack of addressability of nodes, proximity limitations and complexity due to the scale of embedded elements, the CS data structure is used automatically to provide electronic equivalence with greater transformative flexibility. Given the sample texts: “The cat evidently runs. The cat runs evidently.”. Parse trees are created structurally for each sentence with the challenge of automatically determining the correct parts of speech, followed structurally by the correct meanings in the sentence, and then semantic and contextual representation can be attempted. By contrast, CSs form structurally from matched patterns. Elements are added structurally to the consolidated set as they are received, with ambiguous phrases being added automatically to different sets. A data structure phrase becomes ambiguous automatically when it is matched by more than one stored phrase pattern (sequence). Note that set1 and set2 are stored as the words are received, rather than being fitted structurally to a tree structure. During the automatic matching of patterns, WSD limits meanings to those that structurally fit the matched data structure pattern. For languages with free word orders in particular, the Consolidated Set approach seen in an embodiment of the present invention transformatively reduces the combinatorial explosion of possible matches significantly, while increasing accuracy as matched patterns are re-used, free of invalid possibilities through WSD. After a consolidated data structure set is structurally compiled, it can be promoted transformatively to a higher structural level at which point data structure elements are allocated automatically, such as from a collection of phrases to a clause. The diagram illustrates three CS data structure elements in which a noun phrase level matches ‘the cat’, another verb phrase level matches ‘the cat runs evidently’ and the clause level match shows the tagged nucleus ‘runs’ along with its tagged actor and how element.

Levels are allocated structurally based on the electronic inclusion of data structure attributes that automatically identify the layer singly or in combination with others. While a parse tree identifies its structure automatically through the electronic matching of tokens to grammatical patterns with recursion as needed, a phrase pattern matches more detailed data structure elements and assigns them structurally to levels. This structurally enables the re-use of phrases at multiple levels by repetitive matching, not recursion. In the example texts, structural levels are seen. ‘The cat’ is a phrase that must be matched before the clause. Similarly, ‘the dog’, ‘the cat’ and ‘Bill’ must be matched first structurally. With the embedded clause, ‘the dog the cat scratched’ must be matched first as a clause and then re-used with its head noun structurally to complete the clause.

An embodiment of the present invention describes the automatic conversion transformatively between sequential data structure patterns and equivalent data structure sets and back again. As a result, it removes the need for a parse tree and replaces it automatically with a CS data structure for recognition (a CS data structure consolidates all elements of the matched phrase in a way that enables bidirectional generation of the phrase electronically while retaining each constituent for use). As a CS data structure is equivalent to a phrase data structure, the structural embedding of CSs is equivalent to embedding complex phrases. For generation it uses a filled CS data structure, just matched or created, and generates the sequential version automatically. As the set embeds other patterns structurally, the ability for potentially infinite complexity with embedded phrases is available.

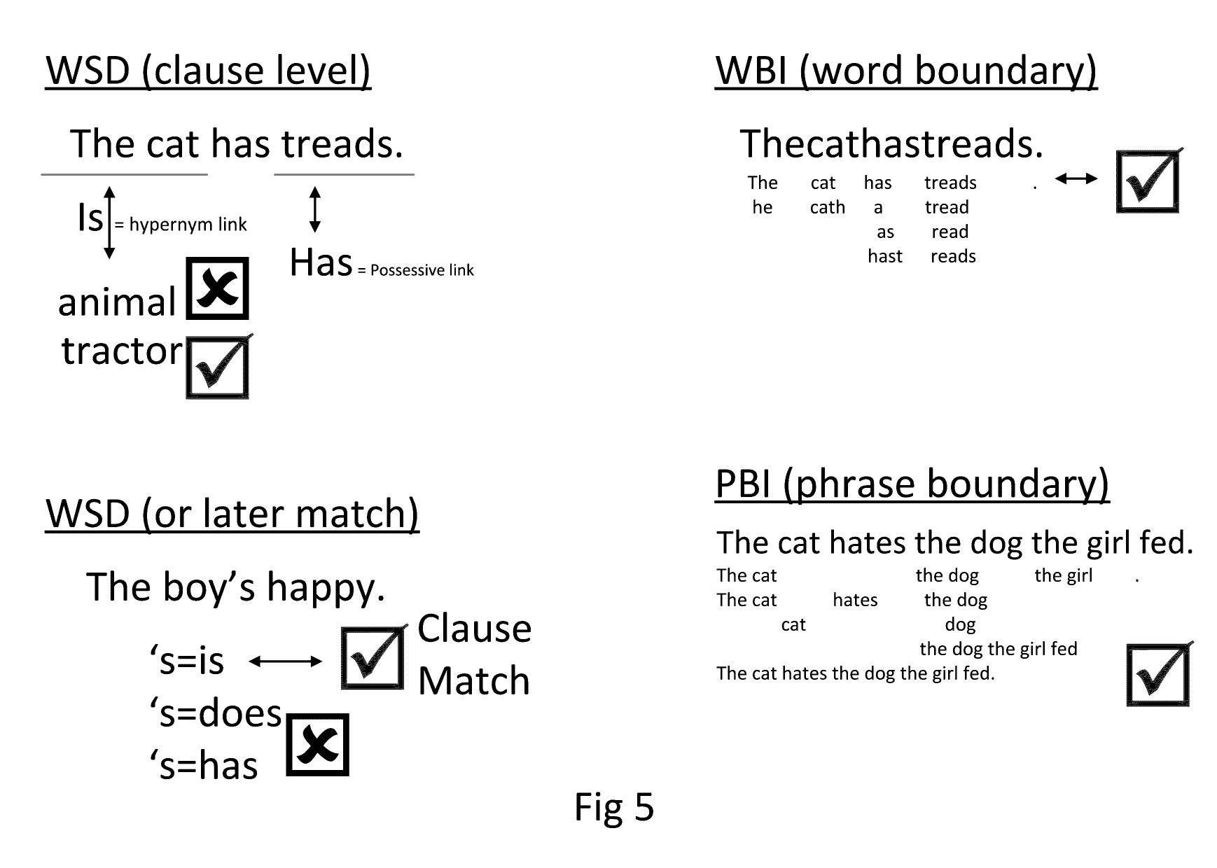

FIG. 5 shows examples of solutions to WSD, WBI and PBI. WBI results from the automatic recognition of word constituents structurally at one level. These are disambiguated at a higher structural level. Similarly PBI is resolved the same way, automatically by matching potential phrases at one level and resolving them by their incorporation into a higher structural level. As data structure patterns are matched from whatever point they start, they are effectively matched independently of sequence at another structural level—the level at which meaning results from the combination of these patterns. Selecting elements in the LS automatically to identify the best fit, results in effective WBI and PBI. The bidirectional nature of elements enables phrase generation.

In the first example, ‘the cat has treads’ has the meaning of the word ‘cat’ disambiguated because one of its hypernyms (kinds of associations), a tractor or machine, has a direct possessive link with a tractor tread. As this is the only semantic match, the word sense for cat meaning a tractor is retained. In the example WSD for “the boy's happy”, three versions of the phrase are matched transformatively with the possible meanings of the word “'s”, but only the meaning where “'s=is” does the disambiguation for the phrase resolve to a clause. For WBI, the system matches a number of patterns at the word level structurally within the text input including ‘cath’, ‘he’ and ‘reads’. The matching of a higher-level phrase pattern that covers the entire input text is selected automatically as the best fit, which in this case resolves structurally to a full sentence. For PBI the same effect seen in WBI resolves PBI by selecting the longest, matching phrase: in this case a noun clause within a clause. While the phrase ‘the cat hates the dog’ is a valid phrase, its lack of coverage when compared with ‘the cat hates the dog the girl fed’ excludes it as the best choice.

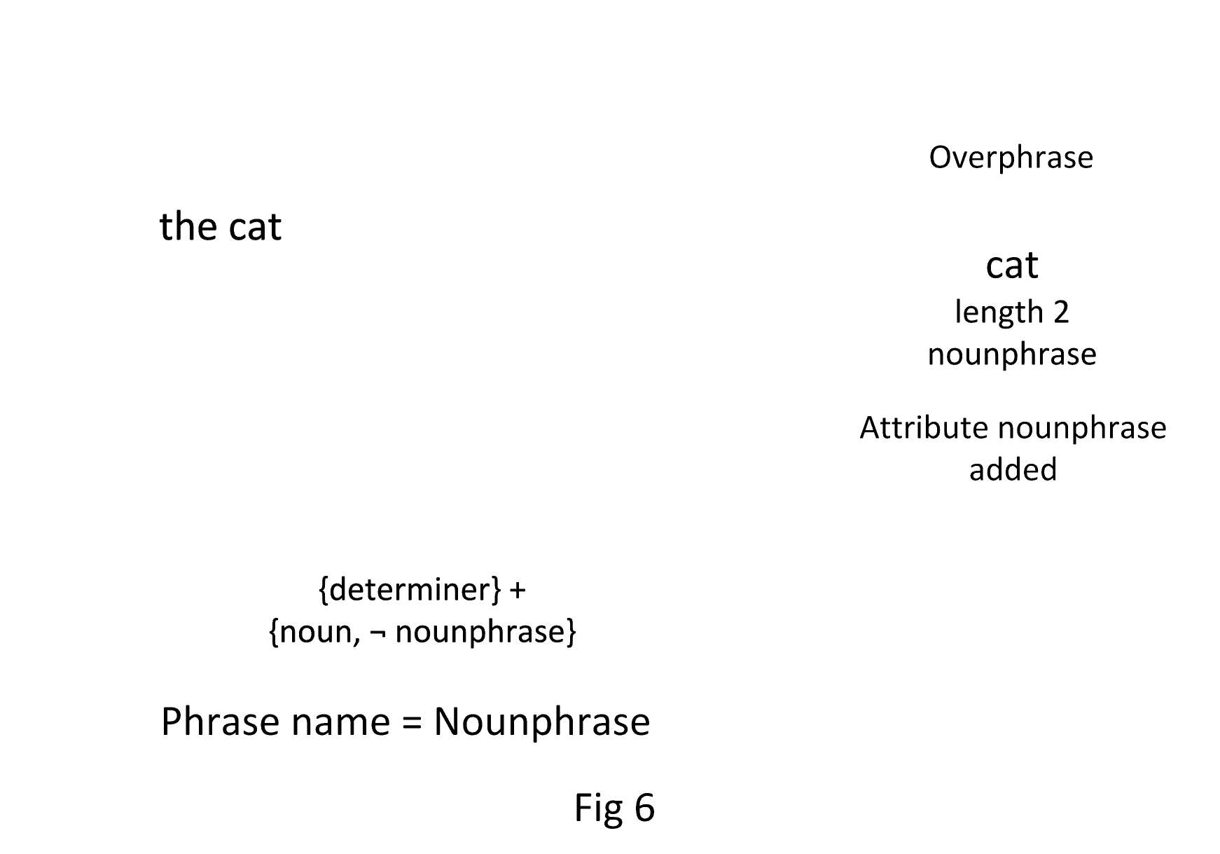

FIG. 6 shows the computer-implemented process to match a sequential phrase pattern to input automatically after which the CS data structure stored fully represents the sequential pattern. The CS data structure reduces transformatively two elements to one. The two elements with text ‘the cat’ is replaced automatically by the head object ‘cat’ with a length of two and a new attribute called ‘nounphrase’. The sequential phrase matched structurally has a length of two starting with a grammatical type of ‘determiner’ and followed by an element with a grammatical type of ‘noun’ but NOT an attribute of type ‘nounphrase’. The inhibiting attribute ‘nounphrase’ is added automatically by this phrase data structure upon successful matching to inhibit electronically further inadvertent matching.

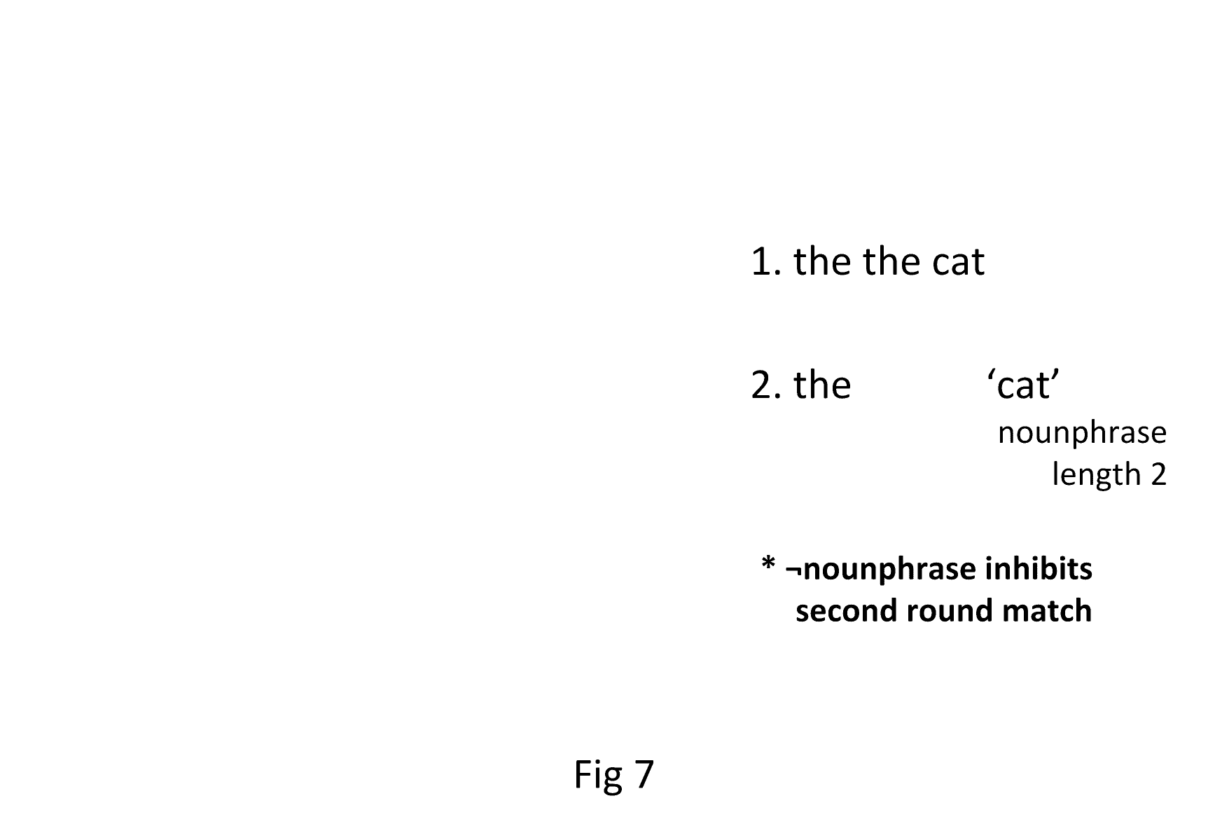

FIG. 7 illustrates how the phrase ‘the the cat’ is inhibited from matching the set created the second time around automatically because an element of the phrase inhibits the subsequent match. Because the phrase ‘the cat’ retains its head's grammatical type of noun structurally, it would match with another leading determiner if not constrained. This electronic inhibition has many applications, a key one of which structurally creates a logical level. Provided the attribute ‘nounphrase’ in this example is only added automatically to phrases without it, those with it must be at a logically higher structural level. These phrases can still be matched, of course, however the general transformative capability is highlighted. The result of matching ‘the the’ is necessary for a stutter for instance. Another attribute can be added to match ‘the the’ to ‘the’+“attribute=duplicate”, for example. In that case, the match would first incorporate ‘the the’ followed by the NounPhrase sequence.

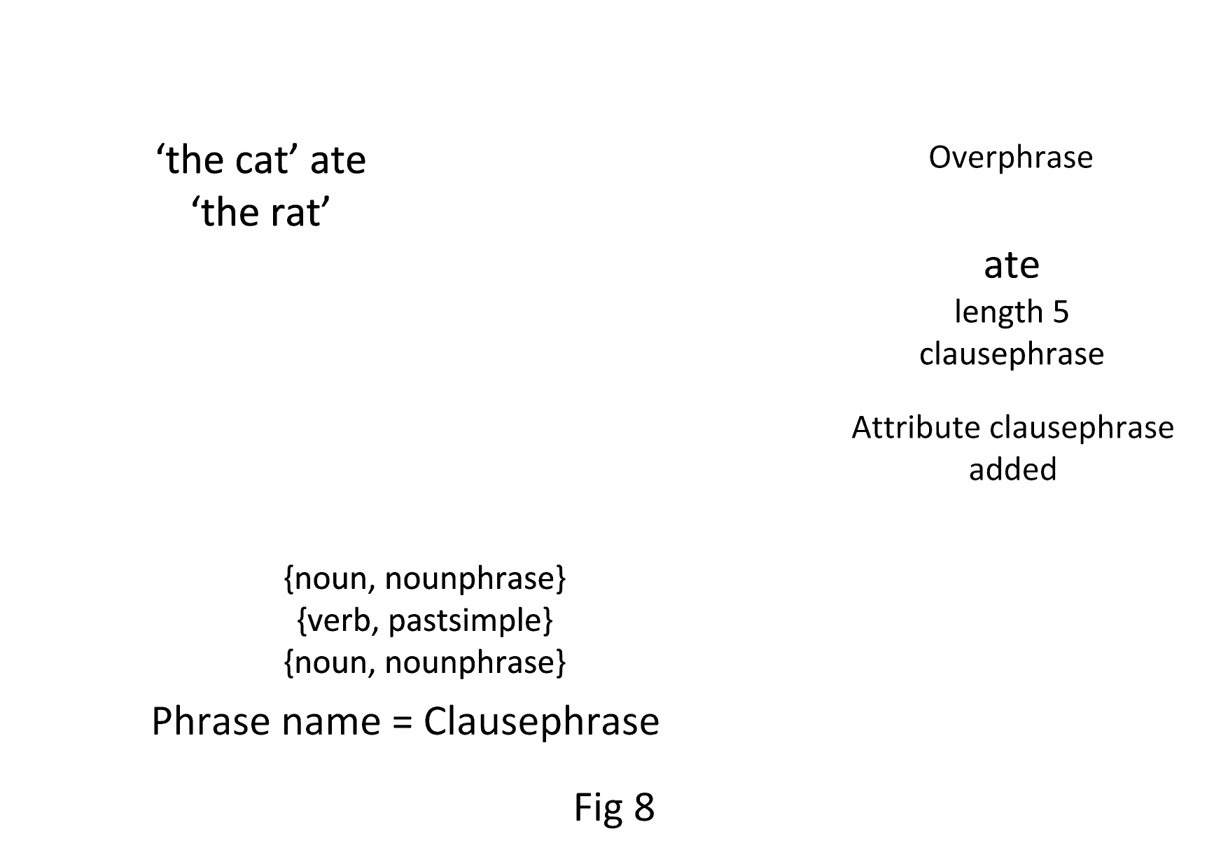

FIG. 8 illustrates an additional layer in which clauses are matched structurally, but only once noun phrases have been matched. In the clausephrase shown, it is comprised of three data structure elements: the first is a noun with the attribute nounphrase, the second is a verb with the attribute pastsimple and the third is also a noun with the attribute nounphrase. Provided the nounphrase attribute is only added by a successful match of such a phrase in any of its forms, the result will be to limit clauses automatically to only those that contain completed noun phrases.

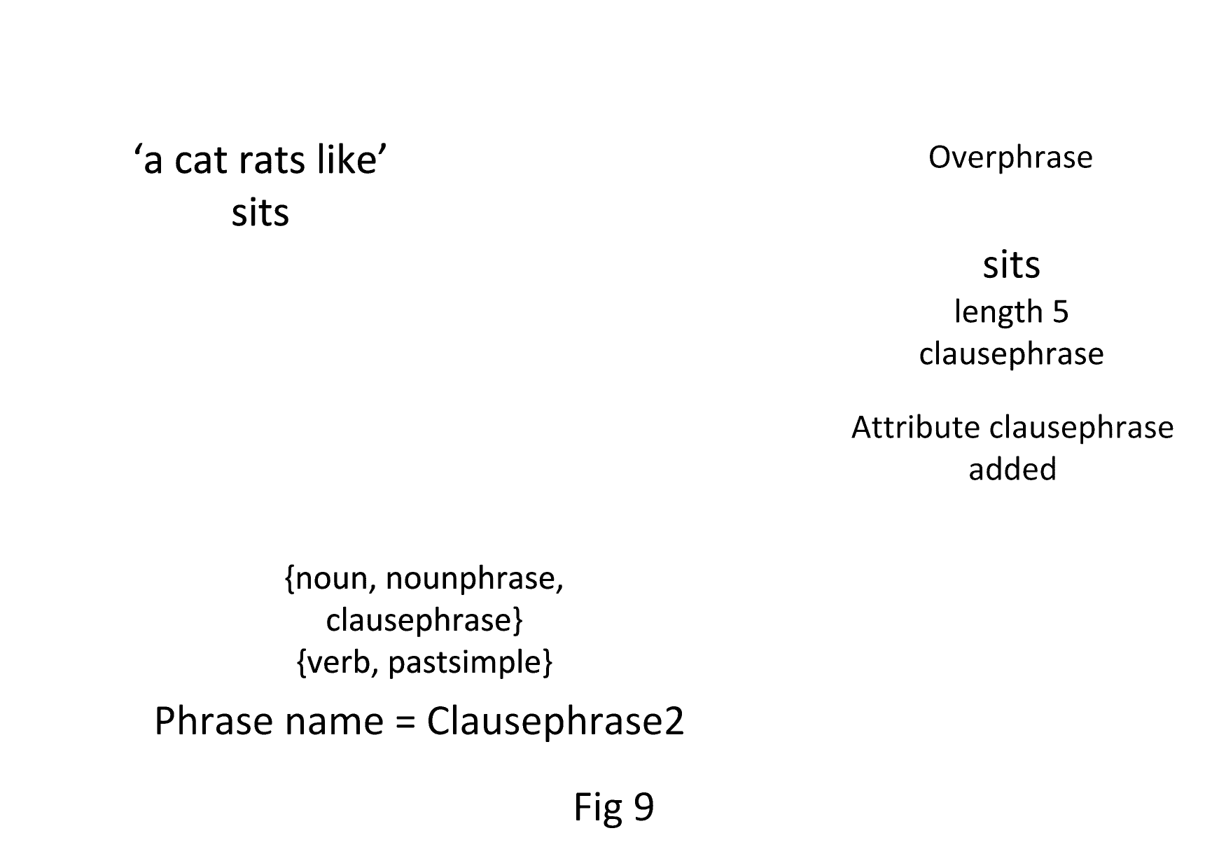

FIG. 9 details another level of structural complexity. In English, the phrase ‘a cat rats like’ is a noun phrase in which the head (retained noun) for use in the sentence is ‘a cat’. It has a meaning like the clause ‘rats like a cat’ but retains ‘a cat’ for use in the subsequent clause (the noun head is retained). In this example, ‘a cat sits’ is the resulting clause where it is also the case that ‘rats like the cat’ in question. On a linguistic note addressing pragmatic discourse, ‘the cat’ is required in my description to be clear that the intended meaning in the embedded clause refers to the same cat.

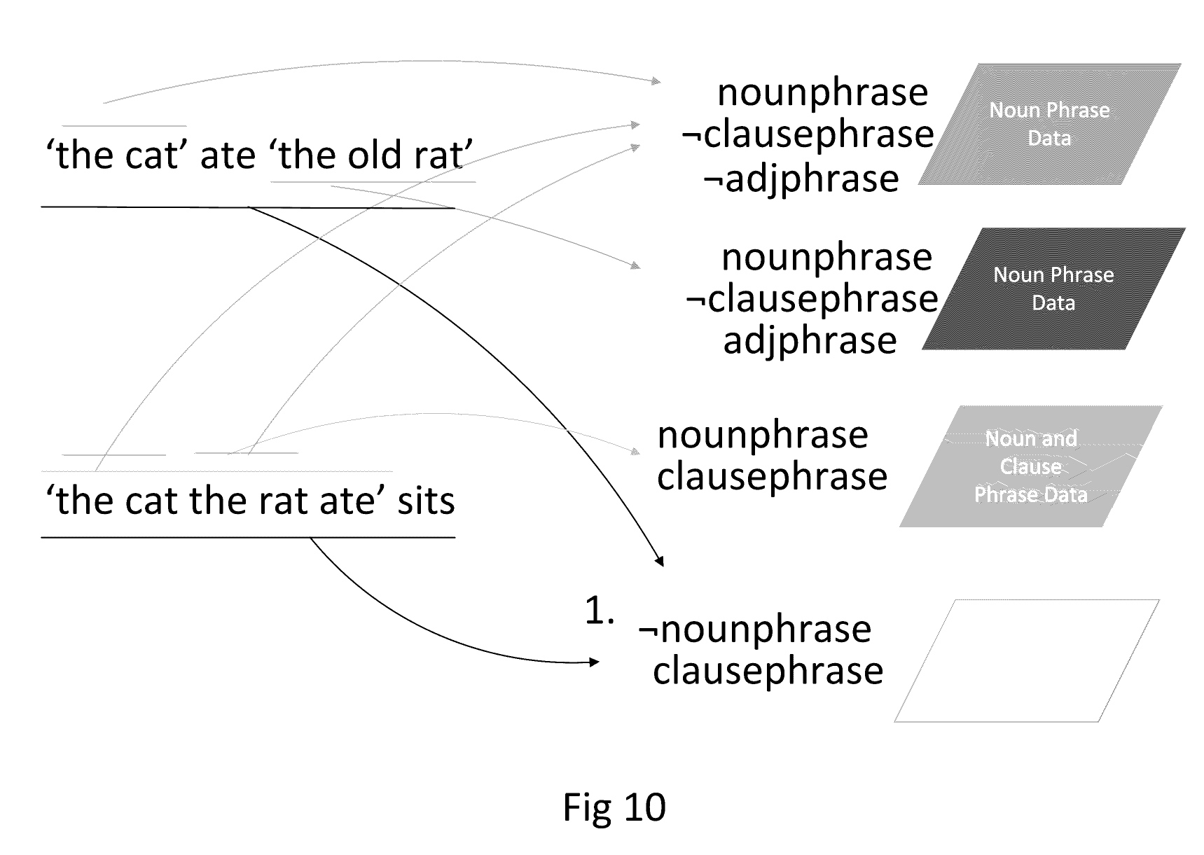

FIG. 10 shows the data structure pattern generation process using only set matching automatically to find correct sequential generation patterns: electronically generating sequential data structure patterns from a set of meaning. The model is bidirectional with the pattern matching from text to clause phrase data sets shown (i.e. a set of data structure elements that define a clause). To match ‘the cat ate the old rat’ automatically, first the noun phrases are matched by two different noun phrase data patterns and the attribute nounphrase added, with adjphrase if applicable. Next the nounphrases are matched in conjunction with the verb and its attributes structurally to identify the full clause. An embodiment of the present invention works in reverse for generation because each level can generate its constituents automatically in turn using only the same set matching process to find the sequential patterns to generate.

The matched phrase ‘the cat ate the old rat’ is generated into a sequence by first finding the set of data structure attributes electronically matching the full clause (labelled ‘1.’) which is stored in a CS data structure. Generation uses the stored attributes automatically to identify appropriate phrase patterns. As ‘1.’ { [symbol] counphrase, clausephrase} matches the final clause, it provides structurally the template for generation: {noun plus nounphrase}, {verb plus pasttense}, {noun plus nounphrase}. Now each constituent of the matched clause identifies appropriate phrases for generation using their attributes transformatively to identify the correct target phrases. In this case one is without an embedded adjective{ [symbol] clausephrase, [symbol] adjphrase, nounphrase} and the other one has and embedded adjective{ [symbol] clausephrase, adjphrase, nounphrase}. When a specific word-sense is required, a word form is selected automatically that matches the previously matched version in the target language. There are no limitations on the number of attributes to match in the target pattern.

FAHQMT uses the filled CS data structure to generate transformatively into any language. The constituents of the CS data structure simply use target language phrases and target language vocabulary from the word senses. The use of language attributes stored with phrases and words to define their language limits possible phrases and vocabulary to the target language.

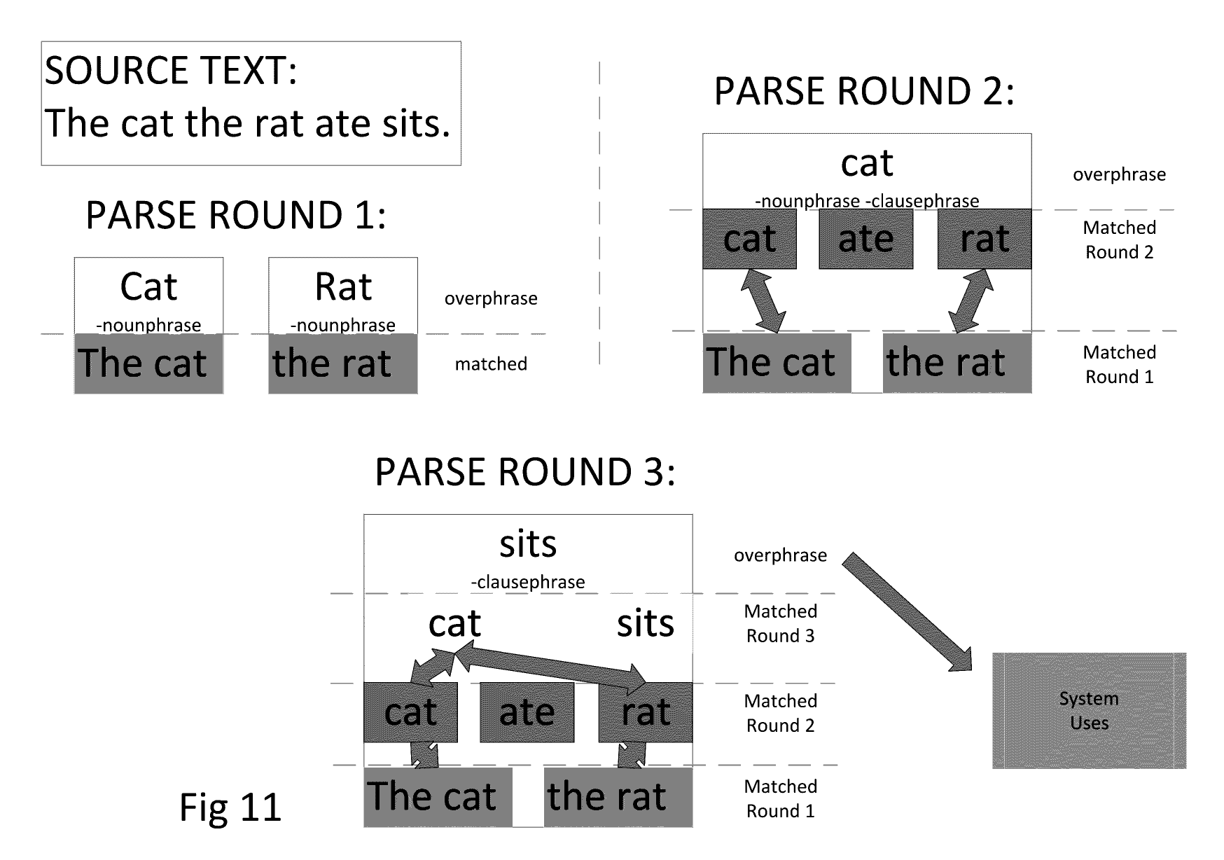

In FIG. 11, the matched phrase ‘the cat the rat ate sits’ similarly find a matching clause phrase and then generates each constituent automatically in turn based on its attributes, one of which is a noun-headed clause. The noun-headed clause will structurally generate embedded nouns using the appropriate converters based on their attributes. In practice, each matching and generating model is language specific, depending on its vocabulary and grammar learned through experience. The matches uses attributes in which phrases are matched in sequence until a full clause results. While the example, ‘the cat the rat eats sits’, matches noun phrases, then a noun clause, and then the full clause, an embodiment of the present invention caters automatically to any number of alternatives. The figure shows the automated matching sequence in which data structure patterns matched at one level become input for the subsequent matching round and other levels. By storing previously matched patterns within the LS, all data structure elements retain full access remains to all levels for subsequent matching.

The system is described as a hardware, firmware and/or software implementation that can run on one or more personal computer, an internet or datacenter based server, portable devices like phones and tablets and most other digital signal processor or processing devices. By running the software or equivalent firmware and/or hardware structural functionality on an internet, network, or other cloud-based server, the server can provide the functionality while at least one client can access the results for further use remotely. In addition to running on a current computer device, it can be implemented on purpose built hardware, such as reconfigurable logic circuits.

What is claimed is:

1. A computer-implemented method for set-based parsing for automated linguistic analysis comprising the steps of:
electronically accessing by a processor a data structure sequence of a source pattern type; and
electronically constructing by said processor at least one Consolidation Set (CS) automatically using pattern matching according to said data structure sequence;
wherein said construction of at least one CS enables said processor to automate set-based parsing for linguistic analysis of the data structure sequence.

2. The method of claim 1 wherein:
said linguistic analysis by said processor uses a Natural Language Processing (NLP) component comprising pattern matching to process the accessed data structure sequence, wherein such analysis automatically finds at least one sentence comprising a plurality of disambiguated words.

3. The method of claim 1 wherein:
said linguistic analysis by said processor uses an Automatic Speech Recognition (ASR) component comprising pattern matching to process the accessed data structure sequence, wherein such analysis automatically finds at least one sentence comprising a plurality of disambiguated words.

4. The method of claim 1 wherein:
said linguistic analysis by said processor uses an Interactive Voice Response (IVR) component to process the accessed data structure sequence for said pattern matching, wherein said processor further uses said IVR component automatically to generate at least one response associated with another data structure sequence associated with at least one reverse pattern in a structural hierarchy of such other data structure sequence.

5. The method of claim 2 wherein:
said linguistic analysis by said processor uses a Fully Automatic High Quality Machine Translation (FAHQMT) component and the NLP component to process the accessed data structure sequence, wherein such analysis automatically resolves at least one phrase to unambiguous content and generation using response capability of an Interactive Voice Response (IVR) component for voice or text-based response.

6. The method of claim 3 wherein:
said linguistic analysis by said processor uses word boundary identification when using the ASR component.

7. The method of claim 2 wherein:
said linguistic analysis by said processor uses word or phrase boundary identification when using the NLP component by automatically resolving at least one higher-level data structure or constituent.

8. A computer-implemented method for set-based parsing for automated linguistic analysis comprising the steps of:
electronically processing by a processor a data structure sequence comprising a plurality of phrases and elements for real-time storage by the processor of such phrases and elements into at least one set, but without storing such phrases and elements in a tree structure; and
electronically converting by said processor said processed data structure sequence transformationally to generate at least one structural description using hierarchical matching.

9. A computer-implemented method for automated linguistic analysis comprising the steps of:
electronically processing by a processor a data structure sequence to determine at least one discontinuity, such that the processor automatically eliminates such discontinuity by matching one or more phrase in the processed data structure sequence; and
electronically consolidating by said processor said processed data structure sequence to generate at least one consolidated set, whereby said processor structures or modifies such generated at least one consolidated set according to any eliminated discontinuity to provide linguistic continuity for the processed data structure sequence.

10. The method of claim 2 wherein:
said linguistic analysis by said processor uses a Word Sense Disambiguation (WSD) component and the NLP component, such that at least one invalid word sense is eliminated through lack of consistency with one or more stored associations.

11. A computer-implemented method for automated linguistic analysis comprising the steps of:
electronically processing by a processor multi-level data structure sequence to determine at least one pattern automatically by accumulating a plurality of recognized patterns provided in auditory, written and/or stored text data structure sequence.

12. A computer-implemented method for automated text-based linguistic analysis comprising the steps of:
electronically processing by a processor a text-based data structure sequence to match and store a plurality of embedded constituents or patterns automatically by parsing such text-based data structure sequence repeatedly until said processor stores no further such match.

13. A computer-implemented method for automated voice-based linguistic analysis comprising the steps of:
electronically processing by a processor a voice-based data structure sequence to recognize at least one disambiguated word while processing at least one accent according to one or more attribute limiter.

14. A computer-implemented method for automated linguistic analysis comprising the steps of:
electronically processing by a processor a data structure sequence to match a first pattern to generate a first set or list of elements;
electronically processing the data structure sequence further by said processor to match a second pattern to generate a second set or list of elements;
wherein said processor enables recognition of complex patterns by adding one or more attributes to the first and second patterns.

15. A computer-implemented method for automated linguistic analysis comprising the steps of:
electronically processing by a processor a data structure sequence to recognize a plurality of phrase patterns, and splitting said plurality of phrase patterns with element tagging to generate at least one set of phrase collection; and
electronically processing by the processor said generated at least one set of phrase collection to generate a structured layer for allocating said tagged elements.

16. Computational apparatus for set-based parsing for automated linguistic analysis comprising:
a processor for processing a data structure sequence of a source pattern type;
wherein said processor constructs at least one Consolidation Set (CS) automatically using pattern matching according to said data structure sequence; said construction of at least one CS enables said processor to automate set-based parsing for linguistic analysis of the data structure sequence.

17. The apparatus of claim 16 wherein:
said linguistic analysis by said processor uses a Natural Language Processing (NLP) component comprising pattern matching to process the accessed data structure sequence, wherein such analysis automatically finds at least one sentence comprising a plurality of disambiguated words.

18. The apparatus of claim 16 wherein:
said linguistic analysis by said processor uses an Automatic Speech Recognition (ASR) component comprising pattern matching to process the accessed data structure sequence, wherein such analysis automatically finds at least one sentence comprising a plurality of disambiguated words.

19. The apparatus of claim 16 wherein:
said linguistic analysis by said processor uses an Interactive Voice Response (IVR) component to process the accessed data structure sequence for said pattern matching, wherein said processor further uses said IVR component automatically to generate at least one response associated with another data structure sequence associated with at least one reverse pattern in a structural hierarchy of such other data structure sequence.

20. The apparatus of claim 17 wherein:
said linguistic analysis by said processor uses a Fully Automatic High Quality Machine Translation (FAHQMT) component and the NLP component to process the accessed data structure sequence, wherein such analysis automatically resolves at least one phrase to unambiguous content and generation using response capability of an Interactive Voice Response (IVR) component for voice or text-based response.

21. The apparatus of claim 18 wherein:
said linguistic analysis by said processor uses word boundary identification when using the ASR component.

22. The apparatus of claim 17 wherein:
said linguistic analysis by said processor uses word or phrase boundary identification when using the NLP component by automatically resolving at least one higher-level data structure or constituent.

23. A computational apparatus for set-based parsing for automated linguistic analysis comprising:
a processor that processes a data structure sequence comprising a plurality of phrases and elements for real-time storage by the processor of such phrases and elements into at least one set, but without storing such phrases and elements in a tree structure; said processor converting said processed data structure sequence transformationally to generate at least one structural description using hierarchical matching.

24. A computational apparatus for automated linguistic analysis comprising:
a processor that processes a data structure sequence to determine at least one discontinuity, such that the processor automatically eliminates such discontinuity by matching one or more phrase in the processed data structure sequence; said processor consolidating said processed data structure sequence to generate at least one consolidated set, whereby said processor structures or modifies such generated at least one consolidated set according to any eliminated discontinuity to provide linguistic continuity for the processed data structure sequence.

25. The apparatus of claim 17 wherein:
said linguistic analysis by said processor uses a Word Sense Disambiguation (WSD) component and the NLP component, such that at least one invalid word sense is eliminated through lack of consistency with one or more stored associations.

26. A computational apparatus for automated linguistic analysis comprising:
a processor that processes multi-level data structure sequence to determine at least one pattern automatically by accumulating a plurality of recognized patterns provided in auditory, written and/or stored text data structure sequence.

27. A computational apparatus for automated text-based linguistic analysis comprising:
a processor that processes a text-based data structure sequence to match and store a plurality of embedded constituents or patterns automatically by parsing such text-based data structure sequence repeatedly until said processor stores no further such match.

28. A computational apparatus for automated voice-based linguistic analysis comprising:
a processor that processes a voice-based data structure sequence to recognize at least one disambiguated word while processing at least one accent according to one or more attribute limiter.

29. A computational apparatus for automated linguistic analysis comprising:
a processor that processes a data structure sequence to match a first pattern to generate a first set or list of elements; said processor processing the data structure sequence further to match a second pattern to generate a second set or list of elements;
wherein said processor enables recognition of complex patterns by adding one or more attributes to the first and second patterns.

30. A computational apparatus for automated linguistic analysis comprising:
a processor that processes a data structure sequence to recognize a plurality of phrase patterns, and splitting said plurality of phrase patterns with element tagging to generate at least one set of phrase collection; said processor processing said generated at least one set of phrase collection to generate a structured layer for allocating said tagged elements.
